(19) United States
(12) Patent Application Publication
(10) Pub. No.: US 2002/0037147 A1
(43) Pub. Date: Mar. 28, 2002

(54) Multi-level optical fiber and component storage tray

(76) Inventors: Thomas McLean, Woodland Hills, CA (US); Eric L. Goldner, Valencia, CA (US)

Correspondence Address: Lewis B. Sternfels, 3100 Inglewood Boulevard, Los Angeles, CA, 90066-1062, US

(21) Appl. No.: 09/921,623

(22) Filed: Jul. 31, 2001

Related U.S. Application Data
(60) Provisional application No. 60/221,822, filed on Jul. 31, 2000.

(51) Int. Cl. G02B 6/00

(52) U.S. Cl. 385/135

(57) ABSTRACT

Single and multi-level structures provide neatly organized, secure and easily repairable optical fiber connections between a pump source laser diode (54) and optical fiber coils represented by x-axis coil (22), y-axis coil (24) and z-axis coil (26). The structures employ specially organized trays (60, 62) for supporting such components as a 1×3 fiber optic coupler (46), an optical isolator (ISO) (48), a wavelength division multiplexer (WDM) (50), a doped fiber coil (52) and a tap coupler (56), and for holding and routing the optical fibers coupled to and between the components. Routing and secure holding of the fibers are facilitated by a built-in optical fiber holder (120), integral with tray (60), and individual optical fiber holders (140), which are stackable upon the built-in holder or upon each other. Each tray includes internal guides, such as a guide post (118), and segmented internal and external walls which provide optical fiber routing paths (96, 100, 160) and wall separations and/or openings (102,104,106,132,162) to permit ingress and/or egress of fibers or attachment points, similar to wall separations (145) in the stackable holders. Special resilient clam-shell holders (168, 172) safely hold the fragile components, and are incorporated within the trays to facilitate inter-structural and exterior coupling.

### CROSS-REFERENCE TO RELATED APPLICATION

This application claims the benefit of U.S. Provisional Application No. 60/221,822, filed Jul. 31, 2000.

### REFERENCE REGARDING FEDERAL SPONSORSHIP

Not Applicable

### REFERENCE TO MICROFICHE APPENDIX

Not Applicable

### BACKGROUND OF THE INVENTION

1. Field of the Invention

The present invention relates to optical fiber connections between and amongst electro-optical components and, more particularly, to an apparatus and a method for supporting such components and for routing optic fibers among these and other components.

2. Description of Related Art and Other Considerations

Fiber optic systems, such as fiber optic gyroscopes, comprise an array of electro-optical components which are interconnected by a set of optic fibers. Like electrical wiring, the optical fiber conductors are routed in a manner that provide effective and safe interconnections which are arranged to enable a modicum of efficiency and a capability for rework. Unlike electrical wiring, optical fiber conductors are very sensitive to bending and other sources of stress and are more subject to breakage and thus require more space. Therefore, they must be handled with somewhat greater care. In addition, repair and rework of apparatus employing such optical fibers need significant additional care.

Furthermore, dressing of the fibers may comprise a simple bundling and taping to hold the fibers together or to attach them to supporting equipment. Such bundling and taping can create damage should rework or repair be needed, and often presents a disorganized and otherwise unattractive appearance to the assembly.

Further, it is important to protect fragile components from physical and thermal shock and damage.

### SUMMARY OF THE INVENTION

These and other problems are successfully addressed and overcome by the present invention by providing a structure which may be arranged in a multi-level construction. Preferably, the structure comprises specially organized trays in which built-in and stackable optical fiber holders may be provided, and in which fiber routing paths and openings are formed within a segmented walled structure.

Special resilient holders hold the fragile components, and are incorporable within the tray structure to facilitate inter-structural and exterior coupling.

Several advantages are afforded by the present invention. Rework and repair is facilitated. An orderly appearance is provided. Storage for additional lengths of optical fiber is provided. Components are protected from physical damage.

Other aims and advantages, as well as a more complete understanding of the present invention, will appear from the following explanation of exemplary embodiments and the accompanying drawings thereof.

### BRIEF DESCRIPTION OF THE DRAWINGS

FIG. 1 is a circuit diagram illustrating a fiber optic gyroscope, in which the several components thereof are interconnected amongst themselves by optical fibers and which require dressing and storage provided by the present invention. The specific optical components are herein represented as “WDM” or wavelength division multiplier, “ISO” or an optical isolator, “1×2” or a 1×2 fiber optic coupler, “1×3” or 1×3 fiber optic coupler, “TC” or a tap coupler, “PM” or a pump monitor photodiode, “MIOC” or multi-function integrated optic circuit, and “PD” or photodiode embodied as PDₓ₁ PD_{Y} and PD_{Z} respectively operating along the x, y and z axes.

FIG. 2 is a perspective view of a large covered optical tray used to hold some electro-optical components, a fiber optic coil, and holders for containing a plurality of optical fibers from a smaller source tray (FIG. 13) coupled to a source of laser radiation.

FIGS. 3 and 4 are perspective and plan views of the large optical tray depicted in FIG. 1 with its cover removed to illustrate its interior portion.

FIG. 5 is an elevational view in partial cross-section of a built-in optical fiber holder integrally formed as part of the large optical tray (shown in FIGS. 2-4), and taken along line 5-5 of FIG. 3.

FIG. 6 is a view of one of three separate stackable optical fiber holders adapted to be inserted and retained within the FIGS. 2-4 large optical tray.

FIG. 7 is a plan view of the stackable optical fiber holder which is illustrated in FIG. 6.

FIG. 8 is a cross-sectional view of the stackable optical fiber holder shown in FIG. 7, taken along line 8-8 thereof.

FIG. 9 is a perspective view of a component holder of resilient material and optical components (“WDM”, “ISO” and “1×3”) held therein for placement within the large optical tray (FIGS. 2-4).

FIG. 9A is a view of the bottom side of the holder of FIG. 9.

FIGS. 10-12 are views of the individual three optical components of FIG. 9 held within the resilient component holder illustrated in FIG. 9.

FIG. 13 is a perspective view of a source optical tray employed to hold an additional electro-optical component (“TC”) and a holder therefor of resilient material for holding and routing of optical fibers from a source of laser radiation to the large optical tray and the pump monitor photodiode (“PM”).

FIG. 14 is a perspective view of a component holder of resilient material for holding a single component (“TC”).

FIG. 14A is a view of the bottom side of the holder of FIG. 14.

FIG. 15 depicts both the large optical and source optical trays (respectively FIGS. 2-4 and 13) and a first or lower level of optical fiber interconnections for a partial implementation of the interconnections. Here, a fiber optic coil and the “WDM”, “ISO” and “1×3” optical components, as retained in their resilient holder, are partially interconnected by optical fibers utilizing the built-in optical fiber holder and one of three separate stackable optical fiber holders. In addition, the source optical tray and its retained “TC” optical component, as retained in its resilient holder, is shown as coupled to a source of laser radiation and the pump monitor photodiode (“PM”).

FIGS. 16a and 16b are similar to that illustrated in FIG. 15, in which two additional stackable optical fiber holders are positioned on the second or upper level of optical fiber interconnections for completing the implementation of the interconnections.

FIG. 17 is an exploded view of the assembled parts of the large optical tray as depicted in FIGS. 2-12, without illustration of the routed optical fibers. Further included are a few additional parts, such as violin-configured covers for the built-in and stackable optical fiber holders and a star-shaped support for the fiber optic coil.

### DETAILED DESCRIPTION OF THE PREFERRED EMBODIMENTS

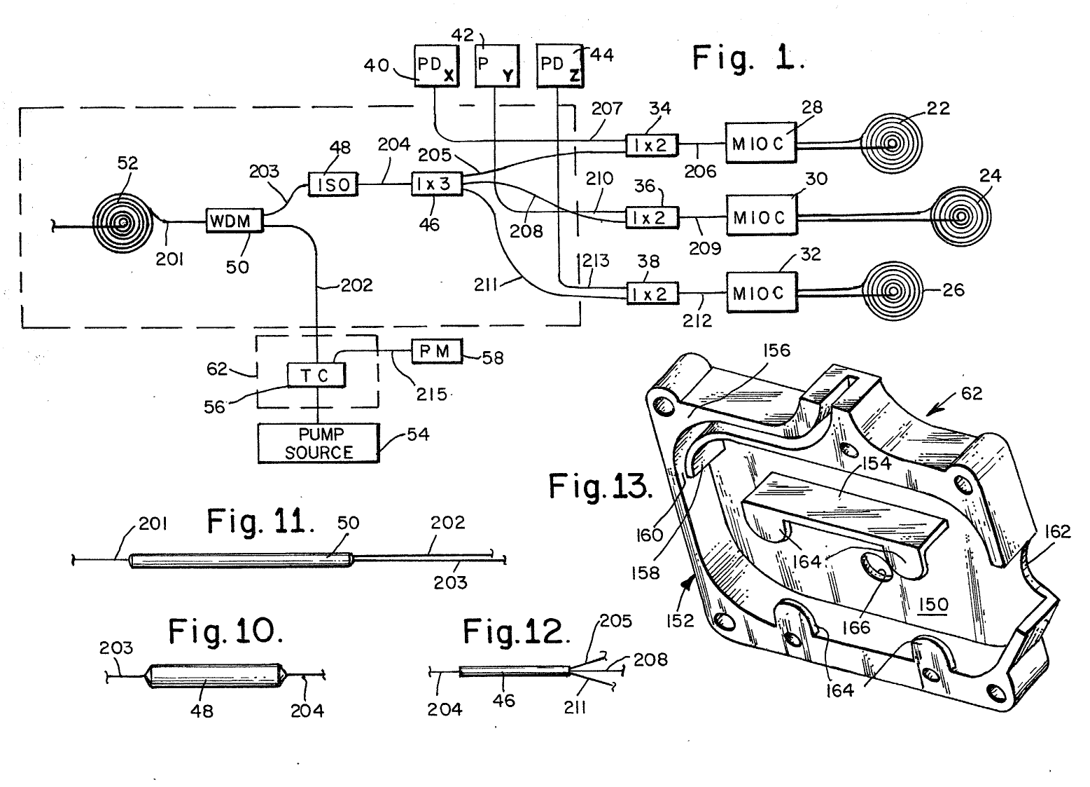

Accordingly, reference is made to FIG. 1, illustrating a circuit diagram 20 comprising an electro-optical arrangement of an electro-optical device, specifically a fiber optic gyroscope, whose three optical fiber coils are represented by x-axis coil 22, y-axis coil 24 and z-axis coil 26. Individual multi-function integrated optic circuits (MIOC) 28, 30 and 32 are respectively coupled to coils 22, 24 and 26. Multi-function integrated optic circuits 28, 30 and 32 are connected respectively by fibers 206, 209 and 212 to 1×2 fiber optic couplers 34, 36 and 38. The single optical fiber connections from their respective multi-function integrated optic circuits 28, 30 and 32 to their 1×2 fiber optic couplers 34, 36 and 38 are each divided into two optical paths, respectively directed along fibers 207,210 and 213 to photodetectors 40,42 and 44 (PDₓ, PD_{Y} and PD_{z}), respectively operating along the x, y and z axes, and along fibers 205, 208 and 211 to a 1×3 fiber optic coupler 46.

Fiber optic coupler 46 is coupled by a fiber 204 to an optical isolator 48 which, in turn, is connected by a fiber 203 to a wavelength division multiplexer 50. Multiplexer 50 is connected by a fiber 201 to a fiber coil 52, e.g., of erbium-doped optical fiber, and by a fiber 202 to a source of laser radiation, comprising a pump source laser diode 54. The interconnection between laser diode 54 and wavelength division multiplexer 50 includes a fiber 214 to a tap coupler 56, which is also coupled by a fiber 215 to a pump monitor photodiode 58.

The above-described arrangement operates in a manner such as described in U.S. Pat. No. 5,311,603. Most of the radiation from laser diode source 54 is directed through tap coupler 56, typically a 95/5% coupler, to wavelength division multiplexer 50. Pump monitor photodiode 58 monitors the radiation emission. The radiation input to wavelength division multiplexer 50 is directed to doped fiber coil 52 where it is down-converted to a longer wavelength, broadband optical output, back into multiplexer 50 for input into optical isolator 48 for distribution into respective 1×2 fiber optic couplers 34, 36 and 38 and respective multi-function integrated optic circuits 28, 30 and 32 for driving x-axis, y-axis and z-axis gyroscope coils 22, 24 and 26.

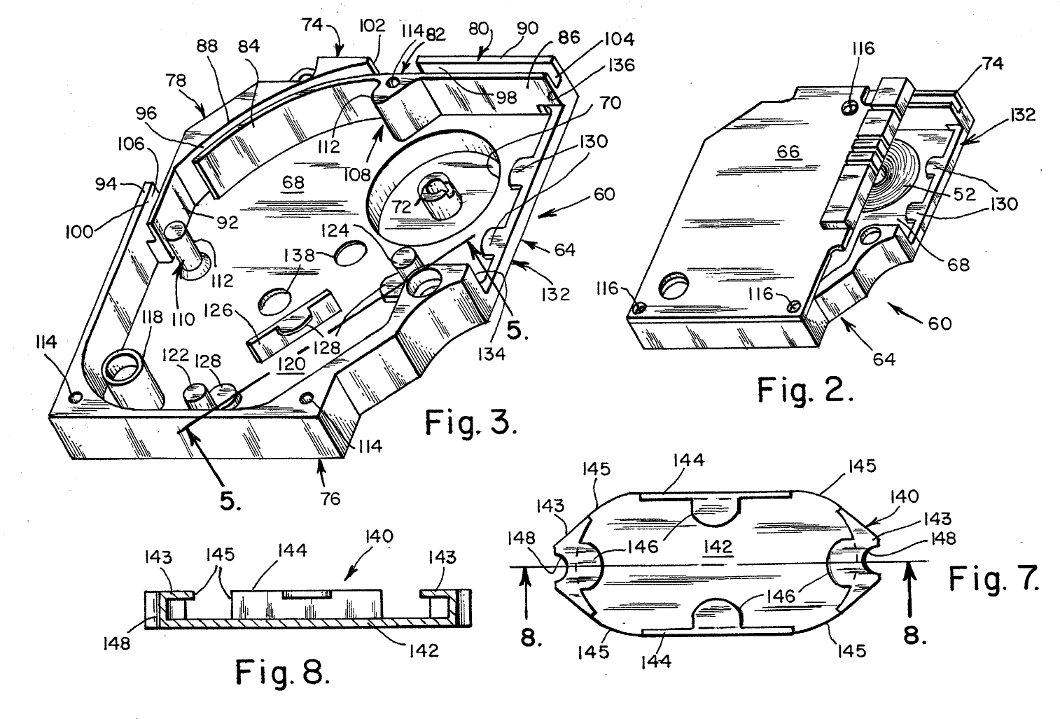

The components and their interconnections are supported in a large fiber optics tray 60 and in an optical source tray 62, shown respectively in FIGS. 2-4 and 13.

Optical large tray 60 includes a base 64 and a cover 66 which is secured thereto in any convenient manner. The base includes a bottom portion 68 from which a cylindrically shaped receptacle 70 extends. Receptacle 70 is provided with a central post 72 and is disposed to hold doped fiber coil 52. The depth of the receptacle is such that the top of doped fiber coil 52 is flush with the upper surface of bottom portion 68. Base 64 is partially surrounded by a walled structure 74 comprising a plurality of inner and outer walls which form and perform multiple functions, including attachment of cover 66 to base 64 and routing paths for optical fibers.

Walled structure comprises outer walls 76, 78 and 80 and an inner wall 82 having portions 84 and 86 adjacent portions 88 and 90 of outer walls 78 and 80. Outer wall 78 also includes an inner portion 92 overlapped by a portion 94 of outer wall 76. These overlapping portion pairs 84 and 88, pairs 86 and 90 and pairs 92 and 94 of the inner and outer walls form respective fiber optic routing paths 96, 98 and 100. Separations 102, 104 and 106 provide inlets and outlets for passage of the optical fibers.

A pair of standards 108 and 110 extend upwardly from bottom portion 68 to a height which is coplanar with the upper surfaces of walls 76 and 82 upon which cover 66 is disposed to rest. Standard 108 forms an integral part of wall 82 while standard 110 comprises a free-standing column. Both standards have curved surfaces 112 for support and registration of stackable optical fiber holders, such as illustrated in FIGS. 6-8, as will be more fully explained below.

Openings 114, which are internally threaded, for example, are formed in wall 76 and standard 108 permit attachment of cover 66 to base 64 through the intermediary of screws 116 as shown in FIG. 2.

A guide post 118 extends upwardly from bottom portion 68 to a height equal to that of walls 76 and 82 and standards 108 and 110.

A built-in optical fiber holder, generally designated by indicium 120, includes a pair of standards 122 and 124 and a wall segment 126 which extend upwardly from bottom portion 68 of the base portion. The spacing between standards 122 and 124 is the same as that between standards 108 and 110, and all have the same curvature denoted by indicium 112. The heights of standards 122 and 124 are the same as those of standards 108 and 110, while the height of wall segment 126 is about half the heights of the standards. Four tabs 128 are respectively formed at the top of wall segment 126 and approximately at the midpoint elevations of standards 122 and 124 and wall 64. Thus, all tabs 128 define a coplanar surface for support of a stackable optical fiber holder, as will be explained below. Tabs 128 extend towards the interior of built-in holder 120 and also provide a cantilevered overhang for retaining optical fibers, as will also be explained below. Additional tabs 130, whose heights are equivalent to those of tabs 128, are positioned at an opening 132 in base 64 extending between ends 134 and 136 of wall 76 and inner wall portion 86 of wall 82.

Base 64 is completed by the provision of a pair of alignment holes 138 in bottom portion 68.

Reference is now made to FIGS. 6-8 which illustrate one of three stackable optical fiber holders 140. Each stackable optical fiber holder 140 is identically formed, and comprises a bottom portion 142 from which four wall segments, paired into segment pairs 143 and 144, extend. The wall segments are spaced from one another to provide separations 145 which provide openings for ingress and egress of optic fibers. Tabs 146 are integral with each of the wall segments of pairs 143 and 144, and jut towards one another and over bottom portion 142, for retention of optical fibers. Wall segment pair 143 each include a cylindrically shaped opening 148 whose curvature matches surfaces 112 of standards 108, 110, 122 and 124. The distance between openings 148 is the same as the spacing between standards 108 and 110 and between standards 122 and 124. The heights of the four wall segments are equal to that of tabs 128 and 130 so that, when one stackable optical fiber holder 140 is positioned on tabs 128 of built-in optical fiber holder 120 as aided by the engagement of openings 148 with standards 122 and 124, and when a pair of stackable optical fiber holders are mounted on standards 108 and 110 as similarly aided by the engagement of openings 148 with standards 108 and 110, the heights of both thus stacked optical fiber holders extend to those of the standards as well as those of all walls. The aforementioned arrangement enables all optical fiber holders to be firmly held in position when cover 66 is placed on and secured to base 64.

As illustrated in FIG. 13, optical source tray 62 comprises a bottom portion 150 from which a walled structure 152 and a wall segment 154 extend. Walled structure includes an exterior wall portion 156 and an interior wall portion 158 spaced therefrom to provide a routing path 160 therebetween for receiving optical fibers. An opening 162 is also formed in walled structure 152, also for ingress and egress of optical fibers. Tabs 164 are formed on wall segment 154 and on walled structure 152 for retaining optical fibers. An alignment hole 166 is positioned in bottom portion 150.

The protective retention and support for 1×3 fiber optic coupler 46, optical isolator (ISO) 48 and wavelength division multiplexer (WDM) 50 is depicted in FIG. 9. A resilient holder 168 of silicone rubber or like material is hinged to form a clam-like thermal and shock resistant enclosure for the major body portions of coupler 46, optical isolator 48 and wavelength division multiplexer 50. The ends of these components, however, extend outside of holder 168 to enable their optical fibers to be routed and connected to the system. Specifically, a single fiber 201 and two fibers 202 and 203 extend from opposite ends of wavelength division multiplexer 50. Single fibers extend from opposite ends of optical isolator 48. A single fiber 204 and three fibers 205, 208 and 211 extend from opposite ends of 1×3 fiber optic coupler 46. As shown in FIG. 9A, resilient holder 168 includes a pair of outwardly extending cylindrical plugs 170 which are adapted to snugly fit within registration holes 138 in bottom portion 68 of base 64 to maintain resilient holder and its held components securely in position.

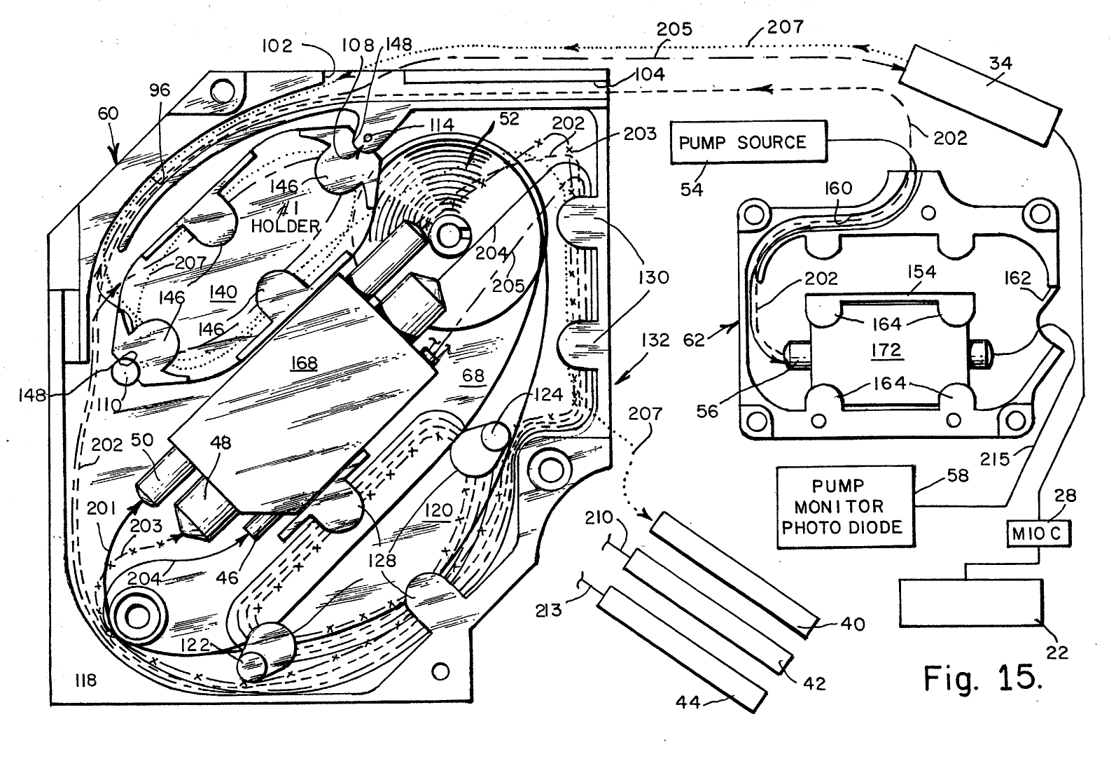

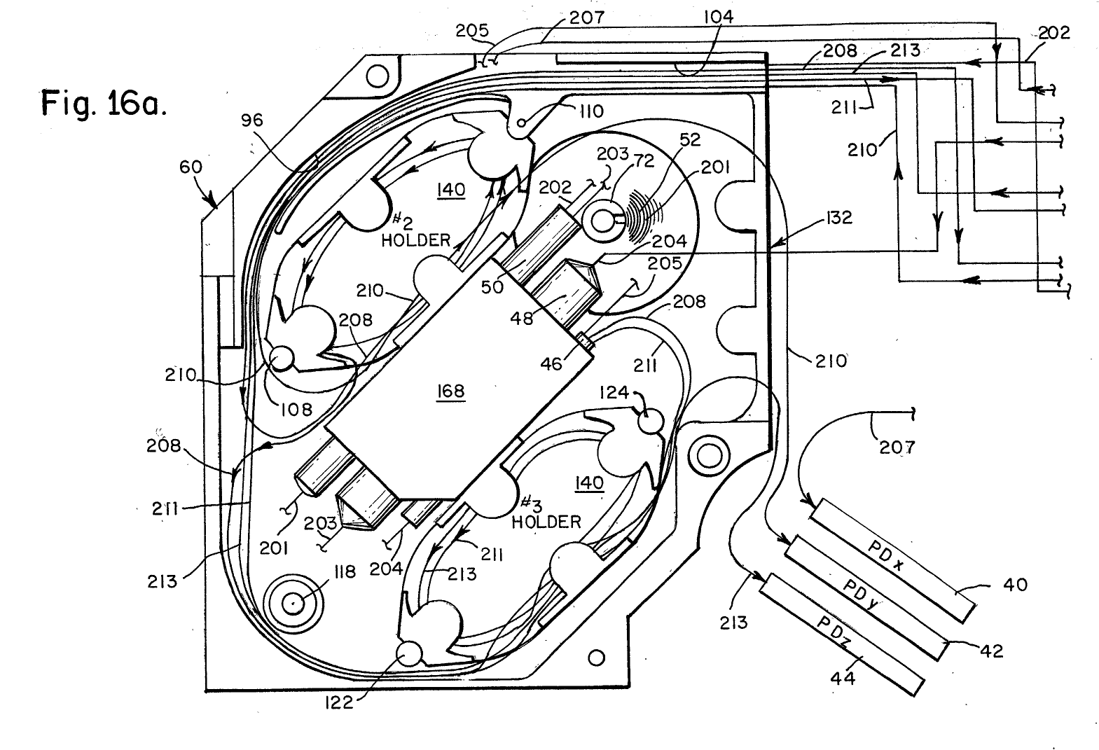

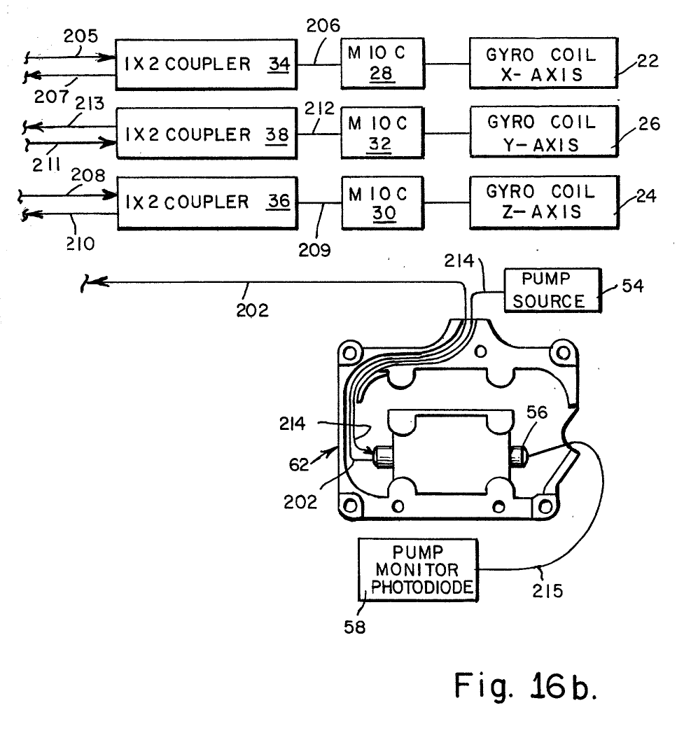

FIG. 14 depicts a resilient holder 172 of silicone rubber or like material hinged to form a clam-like thermal and shock resistant enclosure for securing tap coupler 56 therein in a thermal and shock resistant manner, as depicted in FIGS. 15 and 16. As illustrated in FIG. 14A, a single outwardly extending cylindrical plug 174 is formed in the underside of resilient holder 172 and is adapted to fit snugly within hole 166 of optical source tray 62.

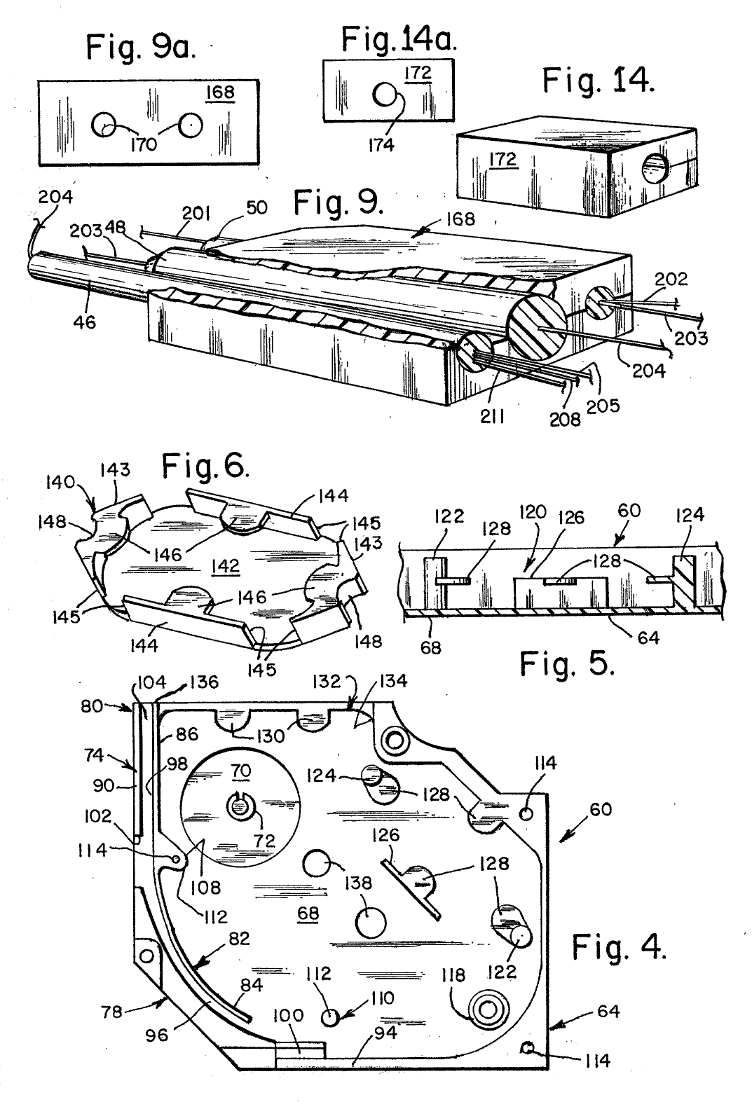

Reference is now made to FIGS. 15 and 16 to illustrate the assembly of the components and optical fibers of the apparatus depicted in FIG. 1 into optical large tray 60 and optical source tray 62. As shown in FIG. 15, for the first level routing, fiber optic coil 52 is placed within cylindrically shaped receptacle 70, and one stackable optical fiber holder 140 in positioned onto bottom portion 68 of base 64 by engaging its cylindrically shaped openings 148 with standards 108 and 110. Resilient holder 168 with its components 46, 48 and 50 therein is placed onto the base bottom portion, ensuring that plugs 170 are engaged within holes 138 (see FIGS. 4 and 9a). Optic fibers 201, 202, 203, 204 and 205 are then routed under tabs 130 and thence inserted into and wound in at least a one loop within built-in holder 120. Because the fibers resist being curved and tend to straighten out, their elasticity enables them to be retained under tabs 128. Upon exiting from built-in optical fiber holder 120, fibers 201, 203 and 204 are directed about guide post 118 to their couplings to respective components 50, 48 and 46. Fiber 205 is similarly directed about guide post 118, but then routed through path 96 and out of base 64 through wall separation 102 to 1×2 coupler 34 for connection to gyro x-axis multi-function integrated optic circuit 28. Fiber 207 is routed from 1×2 coupler 34 through wall separation 102 and into stackable optical fiber holder 140. After it has been looped at least once within holder 140 and under its tabs 146, fiber 207 is directed out of base 64, using tabs 130 as guides, to x-axis photodetector (PDx) 40.

The wiring of optical source tray 62 is also effected by placement of tap coupler 56 within the protective confines of resilient holder 172, which is positioned on bottom portion 150 of the source tray (with plug 174 engaged within hole 166, see FIGS. 13 and 14a). Fiber 215 is coupled to pump monitor photodiode 58 from one end of the tap coupler. Fibers 202 and 214 are routed out of the source tray through path 160, with fiber 214 being coupled to laser pump source 54. Fiber 202 is routed into the large optical tray through wall separation 104, path 96, and around guide post 118 for its coupling through built-in optical fiber holder 120 to wavelength division multiplexer 50, as previously described.

Second level routing and assemblage proceeds, as described with respect to FIGS. 16a and 16b. Two more stackable optical fiber holders 140 are placed respectively above the built-in holder and the first stackable optical fiber holder used with respect with the first level routing described with respect to FIG. 15. The attachments of the holders commence with engaging their cylindrically shaped openings 148 respectively with standards 108 and 110 and with standards 122 and 124 so that they rest upon tabs 149 and 128 of their respective lower holders. Fibers 208 and 211 are then routed to upper level stackable optical fiber holder 140 (positioned above built-in holder 120) and wound around therein under its tabs 149 as described above. Fibers 208 and 211 are then directed around guide post 118, through routing paths 96 and 98 and out from tray base 64 through wall separation 104 for their respective couplings to 1×2 couplers 36 and 38 for connection to their respective y-axis and z-axis gyro coils 24 and 26. Fibers 210 and 213 are routed back into the large optical tray for attachment to their photodetectors 42 and 44 (PD_{Y} and PD_{z}). Here, the routings comprise, for fiber 210, a feeding through paths 98 and 96 to loops within second level stackable optical fiber holder 140 and thence from opening 132 to its photodetector. Fiber 213, after passing through routing paths 98 and 96, is directed about guide post 118, though loops in second level stackable optical fiber holder 140 atop the built-in holder, and out from the tray through opening 132 to its photodetector.

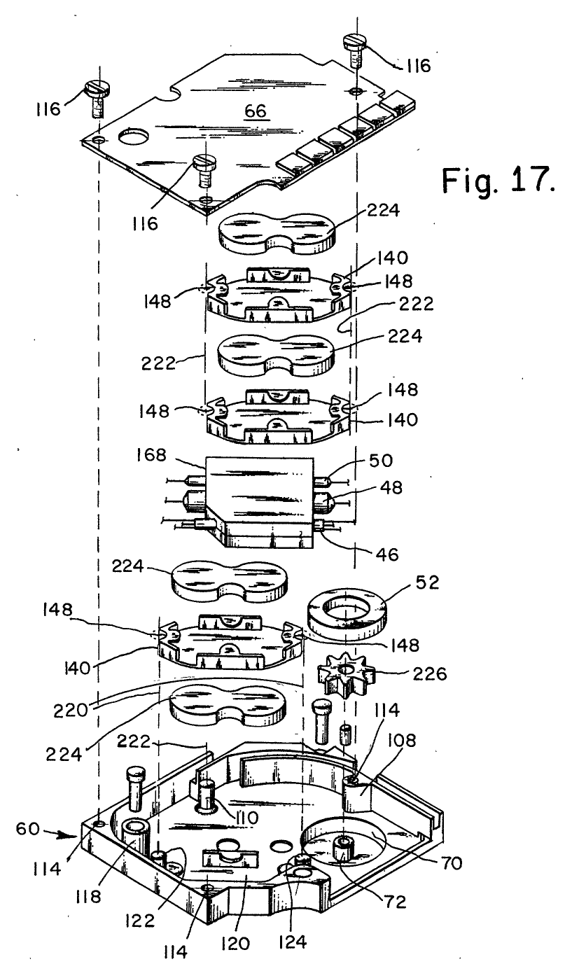

As an aid to visualizing the assemblage and orientation of the components of optical large tray 60, reference is directed to FIG. 17. Here, single stackable optical fiber holder 140 is positioned above built-in optical fiber holder 120 with alignment therebetween, through engagement of openings 148 with standards 122 and 124, being indicated by dashed lines 220. In a like manner, a pair of stackable optical fiber holders 140 are positioned in alignment through engagement of their openings 148 with standards 108 and 1110, as indicated by dashed lines 222. Protection of the optic fibers retained within the several holders is aided by covers 224 which are appropriately shaped to securely retain the wound fibers in their holders while the respective second level holders and cover 66 are installed in place.

Also depicted in FIG. 17 is a star-shaped inner support 226 for fiber optic coil 52. Support 226 is disposed to be mounted on central post 72.

While a single looping of optic fibers have been described within the several optical fiber holders, it is preferable to perform several windings so that, should repair or rework be required, there will remain sufficient optical fiber length available for fiber preparation and splicing, as needed. In addition, while specific routing paths within the several built-in and stackable fiber optic holders and through the several routing paths and wall separations have been specifically detailed, such routings are provided only for the purpose of example. Obviously, the best routing for carrying out the requirements of the specific application will vary from application to application.

Although the invention has been described with respect to particular embodiments thereof, it should be realized that various changes and modifications may be made therein without departing from the spirit and scope of the invention.

What is claimed is:

1. An optical fiber and component storage tray for supporting and routing optical fibers between stations comprising:
a segmented walled structure;
fiber routing paths and openings both formed within said walled structure for routing the optical fibers between the stations; and
holders in said walled structure including portions of said routing paths for supporting and aiding routing of the optical fibers.

2. A tray according to claim 1 in which said segmented walled structure includes interior walls for providing optical fiber routing paths.

3. A tray according to claim 2 in which said segmented walled structure includes walls with openings therein for permitting ingress and egress of the optical fibers into and from said walled structure.

4. A tray according to claim 2 in which said segmented walled structure includes at least one interior post for optical fiber guiding therewithin.

5. A tray according to claim 1 in which said holders are arranged in a multi-level construction to facilitate inter-structural and exterior coupling of the fibers.

6. A tray according to claim 1 in which said holders comprise built-in and stackable holders which are respectively built into said walled structure and are stackable one upon another.

7. A tray according to claim 6 further including a receptacle for receiving a fiber coil coupled to one of the stations and from which the optical fibers extend in said fiber routing paths and said holders.

8. A tray according to claim 7 further including a receptacle for receiving a component holder for holding components to which some of the optical fibers are coupled.

9. A tray according to claim 8 in which said component holder is formed of a resilient material for protecting fragile ones of the components.

10. A tray according to claim 9 in which said component holder includes a number of openings equal in number to the components for supporting an equal number thereof.

11. A tray according to claim 10 in which the openings are sized in accordance with the size of the components.

12. A tray according to claim 1 in which each of said holders includes a bottom portion, wall portions extending from said bottom portion to form a holder interior portion, and tabs extending from said wall portions towards said interior portion, said wall portions forming supports for portions of the optical fibers curled into said interior portion and said tabs providing impediments for resisting movement of the curled optical fibers from the interior portion.

13. A tray according to claim 12 in which said wall portions have openings for permitting ingress and egress of the optical fibers into and from said interior portion.

14. A tray according to claim 13 in which said segmented walled structure includes a bottom portion and said bottom portion of at least one of said holders forms a portion of said walled structure bottom portion, thereby forming a built-in holder fixed with respect to said walled structure.

15. A tray according to claim 14 in which said walled structure includes standards extending from said walled structure bottom portion.

16. A tray according to claim 15 in which another one of said holders includes wall portion segments having openings mateable with said standards for enabling said another one of said holders to be held in position within said walled structure.

17. A tray according to claim 16 in which a further one of said holders is shaped similarly to said another one of said holders, includes wall portion segments having openings mateable with said standards, and is adapted to be stacked atop one of said built-in holder and said another one of said holders.

18. A tray according to claim 14 in which said walled structure includes standards extending from said walled structure bottom portion.

19. A tray according to claim 18 in which another one of said holders includes wall portion segments having openings mateable with said standards for enabling said another one of said holders to be held in position within said walled structure.

20. A tray according to claim 19 in which a further one of said holders is shaped similarly to said another one of said holders, includes wall portion segments having openings mateable with said standards, and is adapted to be stacked atop said another one of said holders.

21. A tray according to claim 20 further including a receptacle for receiving a fiber coil coupled to one of the stations and from which the optical fibers extend in said fiber routing paths and said holders.

22. A tray according to claim 21 further including a receptacle for receiving a component holder for holding components to which some of the optical fibers are coupled.

23. A tray according to claim 22 in which said component holder is formed of a resilient material and is provided with a clam-shell construction for housing and protecting fragile and non-fragile ones of the components.

24. A tray according to claim 23 in which said component holder includes a number of openings equal in number to the components for supporting an equal number thereof.

25. A tray according to claim 24 in which the openings are sized in accordance with the size of the components.

26. A tray according to claim 1 in which each of said holders include interior space of a size capable of holding wind windings of the optical fibers sufficient in length so a to enable repair, rework, preparation and splicing, as needed, of the optical fibers.

27. In a fiber optic gyroscopic system including (a) a plurality of optical fibers, which are amenable to repair, rework and splicing, (b) a source of optical energy connected by the plurality of optical fibers to x-axis, y-axis and z-axis coils and their respective multi-function integrated optic circuits through the intermediary of their 1×2 couplers which are respectively coupled to a series connection of a wavelength division multiplexer, an optical isolator and a 1×3 fiber optic coupler, (c) a tap coupler interconnects the optical energy source to the wavelength division multiplexer, (d) a doped fiber coil is coupled to the wavelength division multiplexer, (e) x-axis, y-axis and z-axis photodetectors coupled to the respective 1×2 couplers, and (f) a pump monitor photodiode coupled to the tap coupler,
an optical fiber and component storage tray apparatus for supporting and routing the optical fibers and for supporting the wavelength division multiplexer, the optical isolator, the 1×3 fiber optic coupler, the doped fiber coil and the tap coupler, comprising:
an optical source tray and an optical large tray;
said optical source tray including
a base portion having a hole therein,
peripheral walls and an interior wall extending upwardly from said base portion,
tabs extending from one of said peripheral walls and said interior wall for defining a holding space,
a resilient clam-shell holder secured about and firmly holding the tap coupler therein in a thermal and shock resistant manner, said resilient clam-shell holder having a plug engaged within the hole and being retained within the interior space between said one of said peripheral walls and said interior wall and under said tabs,
said peripheral walls further defining a routing path and an opening for receipt and ingress and egress of some of the optical fibers for effecting the coupling between the tap coupled and the pump source and the pump monitor photodiode;
said optical large tray including
a large tray bottom portion having a pair of registration holes therein,
a large tray walled structure and a large tray wall segment extending from said large tray bottom portion, said large tray walled structure including an exterior wall portion and an interior wall portion spaced therefrom to provide a routing path therebetween for receiving others of the optical fibers, an opening formed in said large tray walled structure
a large tray resilient clam-shell holder hinged to form a clam-like thermal and shock resistant enclosure for enclosing and supporting the 1×3 fiber optic coupler, the optical isolator, and the wavelength division multiplexer whose ends are coupled by further of the optical fibers for routing and connecting within the system, said large tray resilient clam-shell holder including a pair of outwardly extending cylindrical plugs which snugly fit within the registration holes to maintain said large tray resilient holder and the 1×3 fiber optic coupler, the optical isolator, and the wavelength division multiplexer securely in position, and
holders in said walled structure and positioned in said routing paths for holding and supporting the optical fibers, said holders comprising a built-in holder and separate holders stackable upon one another and said built-in holder and providing interior spaces for holding and retaining selected coiled portions of the optical fibers.

28. A tray according to claim 27 in which said optical large tray further includes pairs of equally spaced-apart standards formed on and extending upwardly from said large tray bottom portion, and said separate holders include pairs of equally spaced-apart openings disposed to mate with said bottom portion pairs of equally spaced-apart standards for enabling the stacking of said separate trays.

29. A tray according to claim 28 in which each of said separate holders includes a bottom portion, wall portions extending from said bottom portion to form a holder interior portion, and tabs extending from said wall portions towards said interior portion, said wall portions forming supports for portions of the optical fibers curled into said interior portion and said tabs providing impediments for resisting movement of the curled optical fibers from the interior portion.

30. A tray according to claim 12 in which said wall portions have openings for permitting ingress and egress of the optical fibers into and from said interior portion.

31. A method for supporting and routing optical fibers coupled between stations comprising the steps of:
routing the optical fibers through fiber routing paths and openings both formed within a walled structure in an optical fiber and component storage tray; and
supporting and coiling at least some of the optical fibers in holders in the walled structure.

32. A method according to claim 31 further including the step of providing the walled structure with interior walls for effecting at least some of the optical fiber routing paths.

33. A tray according to claim 31 further including the steps of providing the walled structure with walls having openings therein for permitting ingress and egress of the optical fibers into and from the walled structure.

34. A tray according to claim 31 further including the steps of forming the holders as holders built-into the walled structure and as separate holders which are stackable upon one another.

35. A tray according to claim 34 in which said holder forming step comprises the steps, for each of the holders, of forming a walled interior space and tabs overhanging the interior space in which the walls of the walled interior space support portions of the optical fibers curled therein and the tabs provide impediments for resisting movement of the curled optical fibers from the interior portion.

36. A tray according to claim 35 further including the steps of providing openings in the walls of the interior space for permitting ingress and egress of the optical fibers into and from the interior space.

37. A tray according to claim 36 further including the steps of providing paired, equally distanced standards in the walled structure, paired engagement portions in the separate holders, and effecting the stacking through engagement of the paired engagement portions with the standards.

38. A tray according to claim 31 further including the steps of providing a receptacle in the walled structure for receiving at least one component holder for holding at least one component to which some of the optical fibers are coupled and forming the component holder of a resilient material for protecting fragile ones of the components.
